(19) United States
(12) Patent Application Publication
(10) Pub. No.: US 2005/0050002 A1
(43) Pub. Date: Mar. 3, 2005

(54) Apparatus and method of presenting textual material to enhance readability for people who have difficulty distinguishing left from right

(76) Inventor: Benjamin Slotznick, Mt. Gretna, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/888,081

(22) Filed: Jul. 9, 2004

Related U.S. Application Data
(60) Provisional application No. 60/486,796, filed on Jul. 11, 2003.

(51) Int. Cl. G06F 7/00

(52) U.S. Cl. 707/1

(57) ABSTRACT

A printed publication, reading display surface, or electronic display screen is provided with a left-right asymmetrical design that extends along left-right edges of the printed publication, reading display surface or electronic display screen that flank text to be read. The asymmetrical design is used by the reader to assist in distinguishing left from right while reading the text.

### CROSS-REFERENCE TO RELATED APPLICATIONS

This application claims the benefit of U.S. Provisional Application No. 60/486,796 filed Jul. 11, 2003 entitled “METHOD OF PRESENTING TEXTUAL MATERIAL TO ENHANCE READABILITY FOR PEOPLE WHO HAVE DIFFICULTY DISTINGUISHING LEFT FROM RIGHT.”

### BACKGROUND OF THE INVENTION

Some people have a hard time remembering the spatial distinctions of right and left. This is not merely forgetting the names right and left, but having difficulty with the spatial concepts, and difficulty applying them consistently.

For such people, the task of reading may be hard to learn, or hard to accomplish on a regular basis. That is because in most languages, reading includes aspects in which one must sequence tasks in a left-to-right order (e.g., English) or a right-to-left order (e.g., Hebrew). Even languages in which letters are arranged vertically, so that individual words and sentences are read from top to bottom, usually order distinct lines of text in a standard spatial manner (left-to-right or right-to-left).

Computer monitors usually include screens held in a plastic or metal casing of one uniform color. The housings are usually white, beige or black. Sometimes the housings of laptops are a brushed metal look. The housing may contain buttons for screen adjustment, corporate logos of the monitor manufacturer, and the like.

Browsers and other software programs for viewing electronic documents are generally plain windows with a uniform color scheme determined by the operating system. Sometimes the top title line is a different color, but not the side bars. Tool bars specific to different viewers may line the top, bottom or sides of the window.

### BRIEF SUMMARY OF THE INVENTION

The producer of textual material or equipment for viewing textual material makes an asymmetrical design (in a left-right asymmetry) that is always visible when viewing any page of the textual material, in order to help a reader to visually distinguish left from right, even if the reader cannot remember the spatial concepts. The asymmetrical design can have an asymmetry of shape, size, design, color, texture and/or decoration.

The term “textual material” includes, but is not limited to, physical books, electronic books, electronic text and web pages.

### BRIEF DESCRIPTION OF THE DRAWINGS

The above summary, as well as the following detailed description of a preferred embodiment of the invention, will be better understood when read in conjunction with the following drawings. For the purpose of illustrating the invention, there is shown in the drawings embodiments that are presently preferred, and an example of how the invention is used in a real-world project. It should be understood that the invention is not limited to the precise arrangements and instrumentalities shown. In the drawings:

FIG. 1A shows a web page displayed in a web browser without the use of the present invention.

FIGS. 1B-1E show the web page of FIG. 1A displayed in a web browser having a left-right asymmetrical design in accordance with preferred embodiments of the present invention.

FIG. 2A shows the web page of FIG. 1A displayed in a web browser having a left-right asymmetrical design in accordance with another preferred embodiment of the present invention.

FIGS. 2B-2F show a printed publication having a content portion and a left-right asymmetrical design in accordance with another preferred embodiment of the present invention.

FIG. 3 shows the web page of FIG. 1A displayed in a web browser having a left-right asymmetrical design in accordance with another preferred embodiment of the present invention.

FIG. 4 shows a computer monitor having a web page displayed in a web browser without the use of the present invention.

FIG. 5A shows a computer monitor of FIG. 4 having a left-right asymmetrical design physically mounted thereon in accordance with another preferred embodiment of the present invention.

FIG. 5B shows a reading stand having a left-right asymmetrical design physically mounted thereon in accordance with another preferred embodiment of the present invention.

FIG. 6 is a flowchart of one preferred embodiment of the present invention.

FIG. 7 is a block diagram of apparatus for implementing the steps of FIG. 6.

FIG. 8 is a flowchart of another preferred embodiment of the present invention.

### DETAILED DESCRIPTION OF THE INVENTION

Certain terminology is used herein for convenience only and is not to be taken as a limitation on the present invention. In the drawings, the same reference letters are employed for designating the same elements throughout the several figures.

### I. Overview of Present Invention

The above summary, as well as the following detailed description of a preferred embodiment of the invention, will be better understood when read in conjunction with the following drawings. For the purpose of illustrating the invention, there is shown in the drawings an embodiment that is presently preferred, and an example of how the invention is used in a real-world project. It should be understood that the invention is not limited to the precise arrangements and instrumentalities shown. In the drawings:

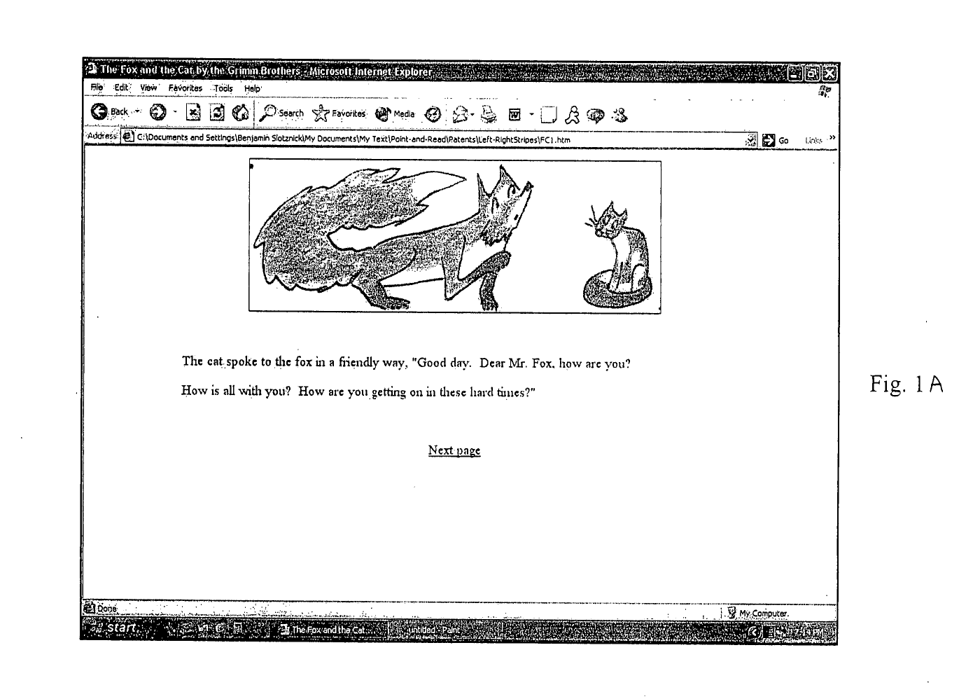

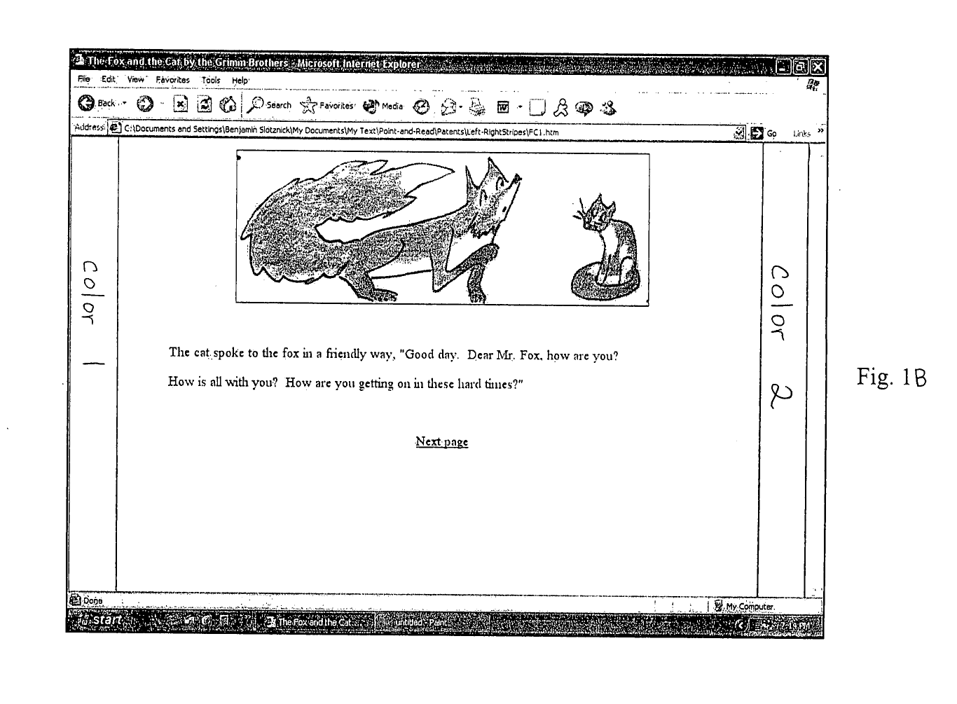

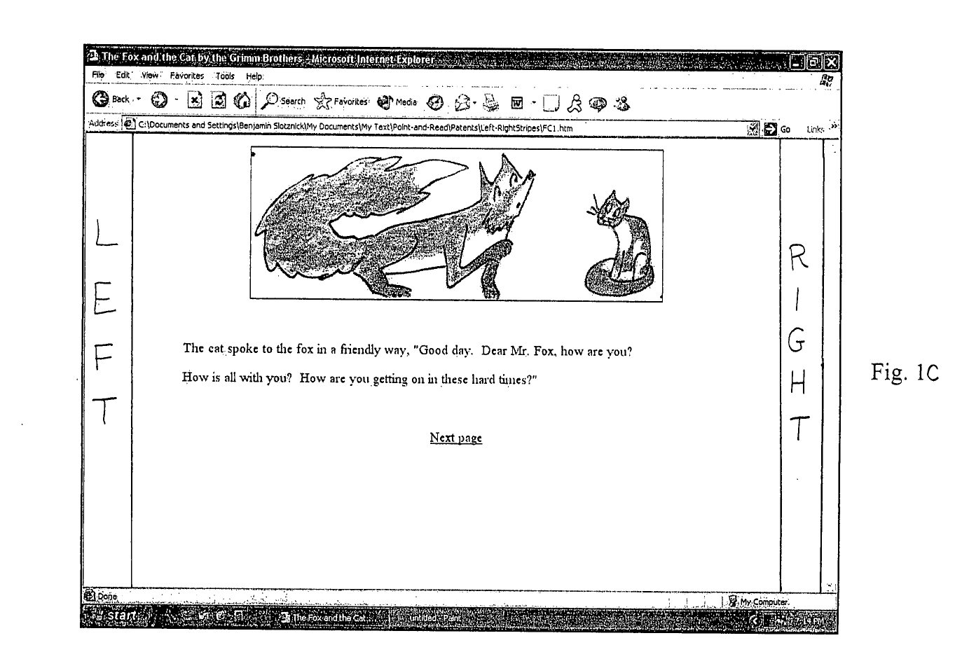

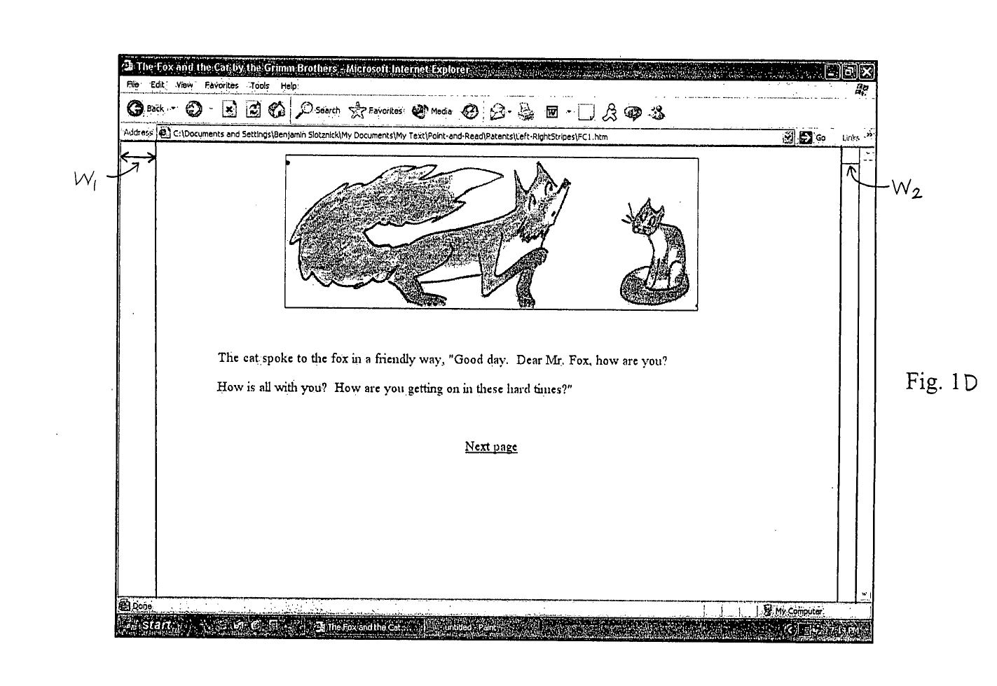

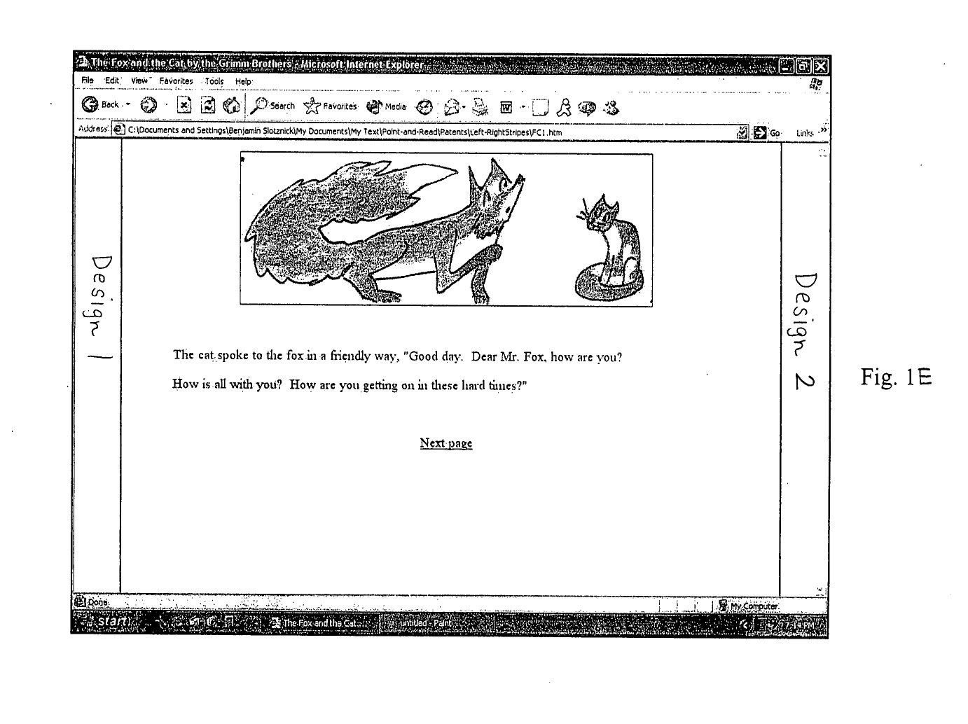

FIG. 1A shows a page from a Grimm Brothers fairy tale without the invention. (The illustration is copyrighted by Benjamin Slotznick.) In one example, the page is printed on paper (or some other physical material). In another example the page is electronic and composed in HTML. The HTML page is shown in a browser such as Microsoft's Internet Explorer. Both the electronic and printed page examples would look like FIG. 1A.

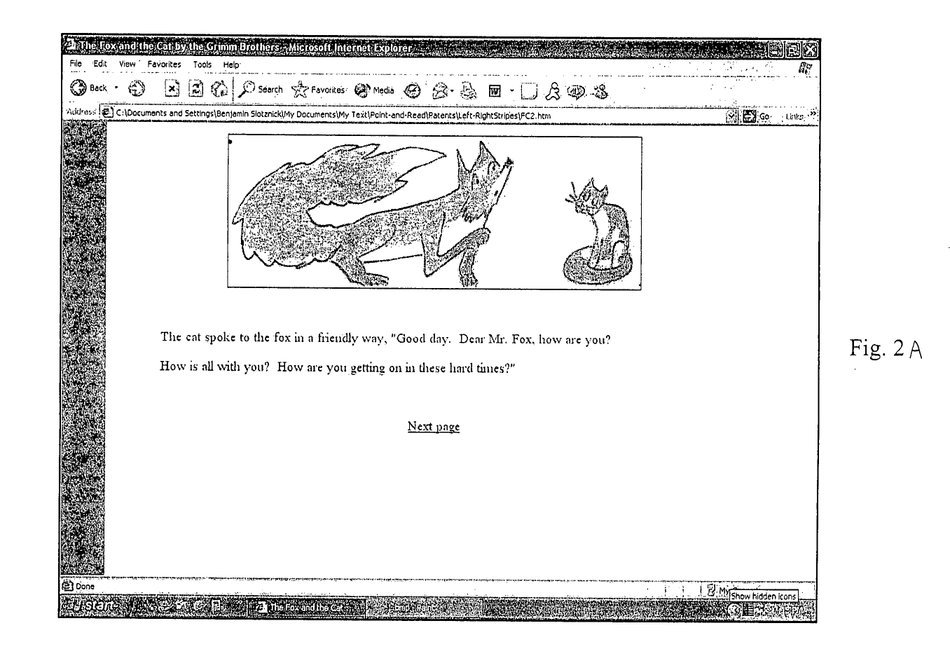

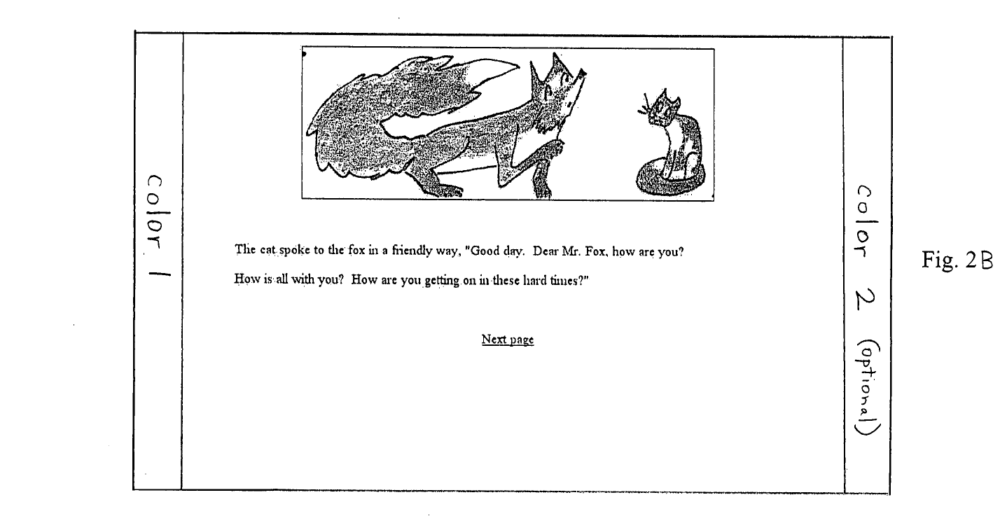

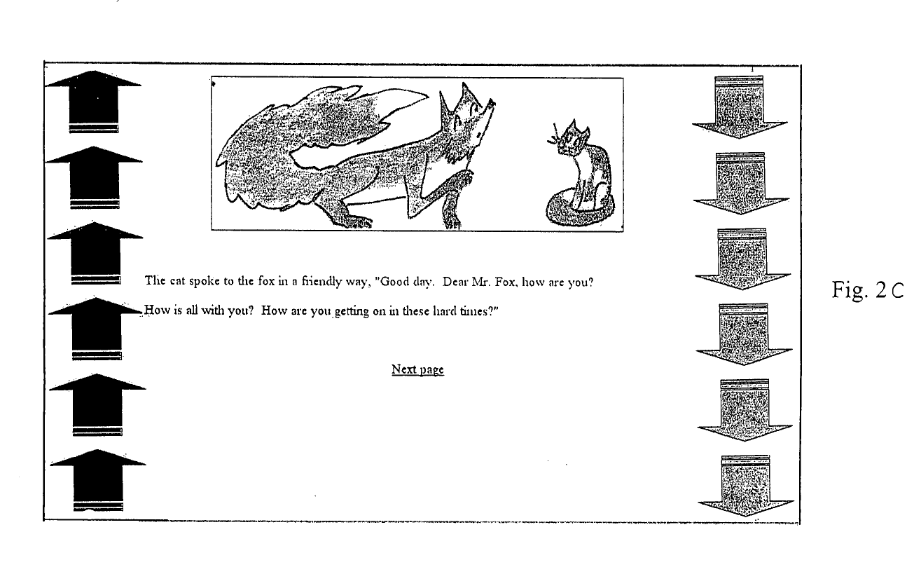

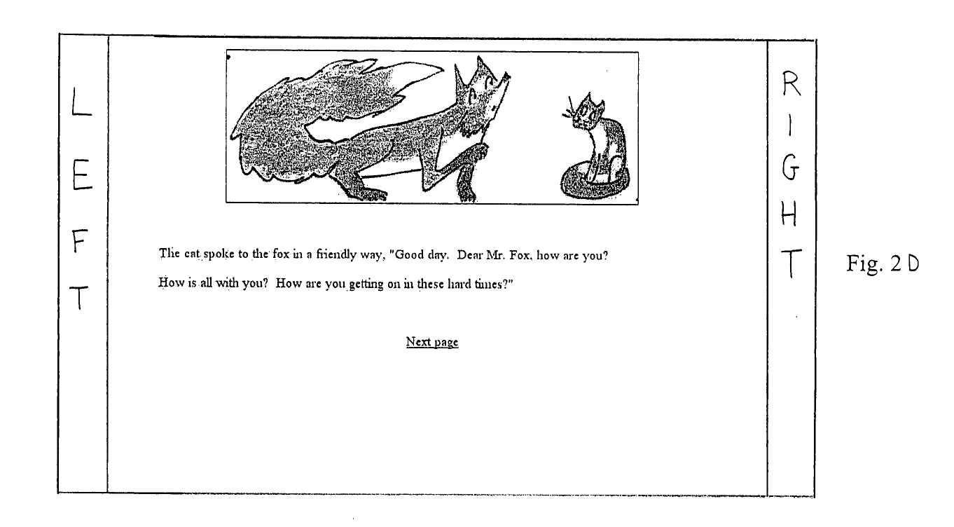

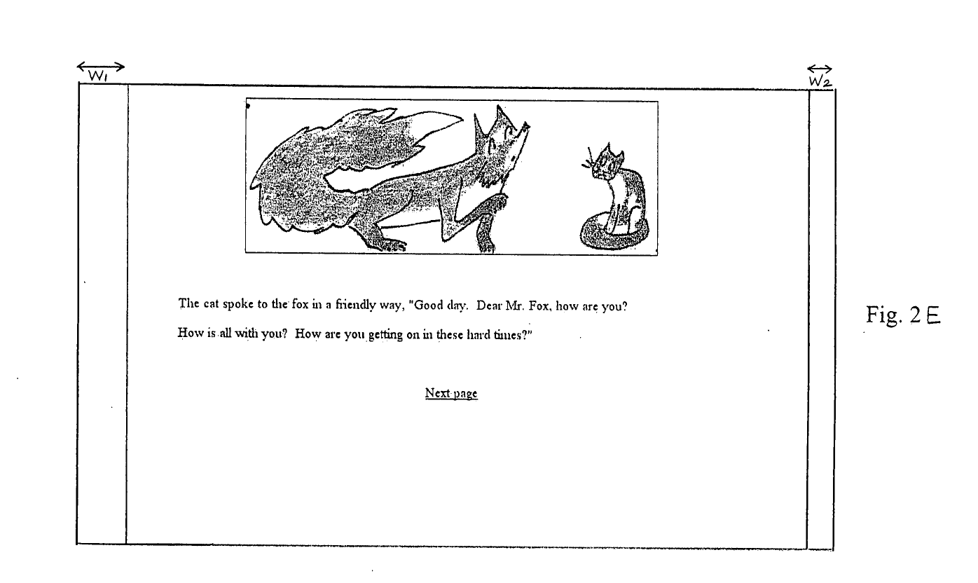

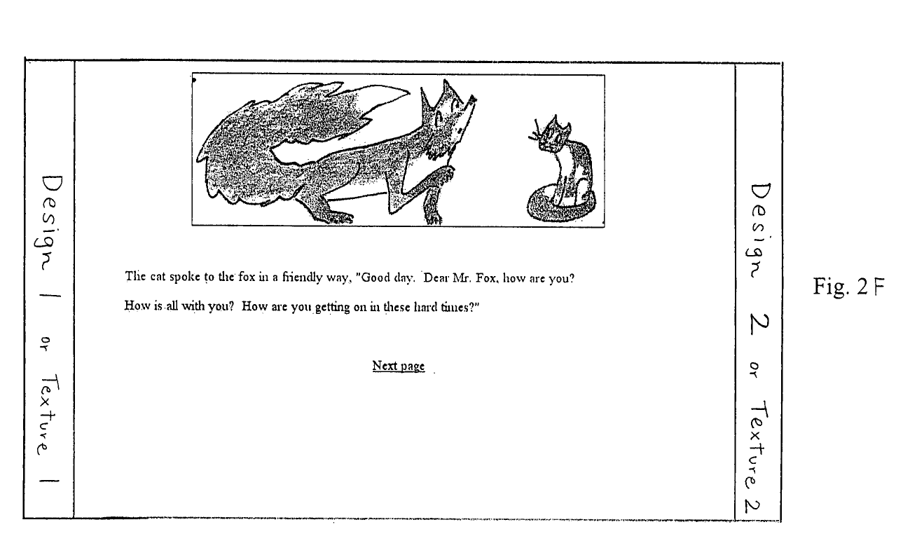

FIG. 2A shows the same page of textual material which has incorporated one preferred embodiment of the present invention in the form of a light stripe on the left side of the page. In one scheme where the textual material is printed on a physical page, the stripe is printed in some distinguishable color such as lavender. In some physical embodiments, the stripe is given texture by embossing, or textured ink. In another scheme where the textual material is electronic and formatted in HTML, the stripe is generated by an image that is specified by an HTML background tag or other code which generates the image of a stripe on the computer monitor. The code for the, stripe may appear in the original HTML page and may be inserted by the creator or producer of the textual material. Alternatively, the code for the strip may be inserted by a computer program prior to displaying the page. In this embodiment, this tag and image do not appear in the original page at its website.

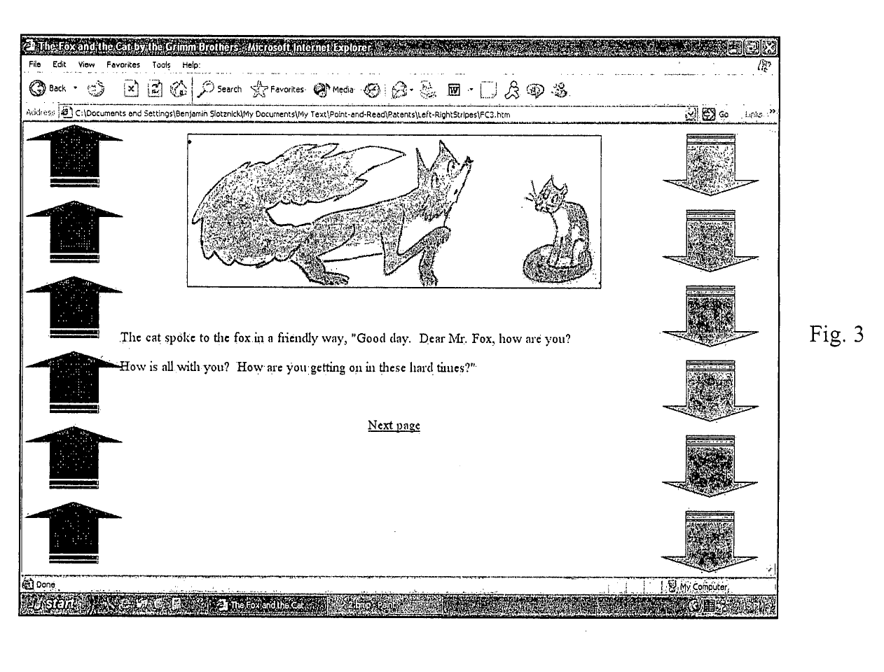

FIG. 3 shows the same page of textual material, but with the asymmetric design including a column of arrows pointing upwards on the left side of the page and a column of arrows pointing downwards on the right side of the page. The arrows on the left are a different color than the arrows on the right. In one embodiment of the present invention where the textual material is electronic, the arrows are animated and appear to move in the same direction in which they point.

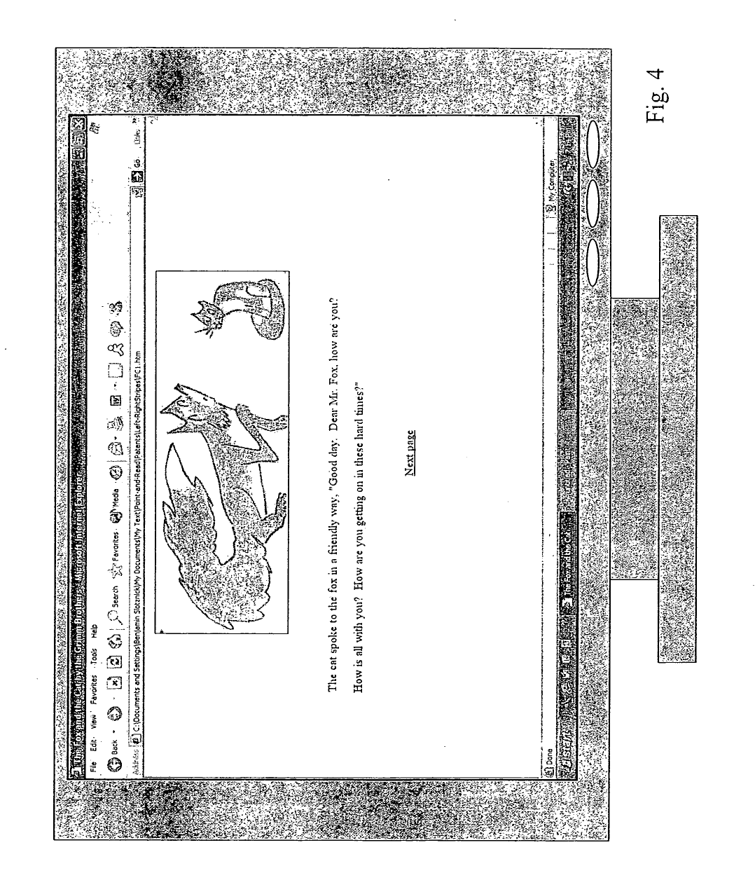

FIG. 4 shows a page of electronic textual material from a Grimm Brothers fairy tale (FIG. 1A) as displayed on a computer monitor. It is shown in a browser such as Microsoft's Internet Explorer. In FIG. 4, neither the monitor (the hardware) nor the browser (the software) incorporate the invention.

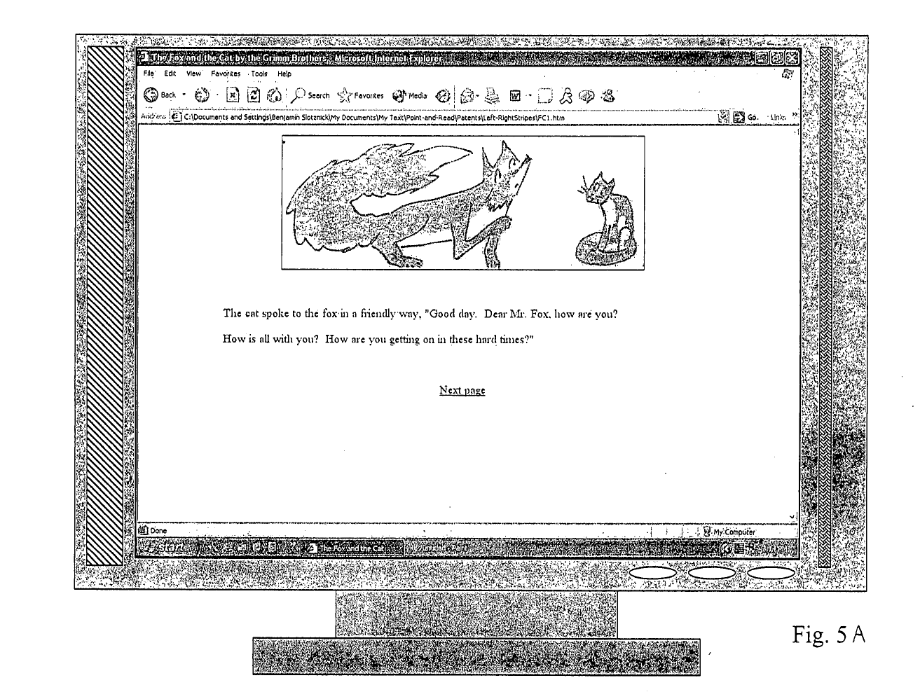

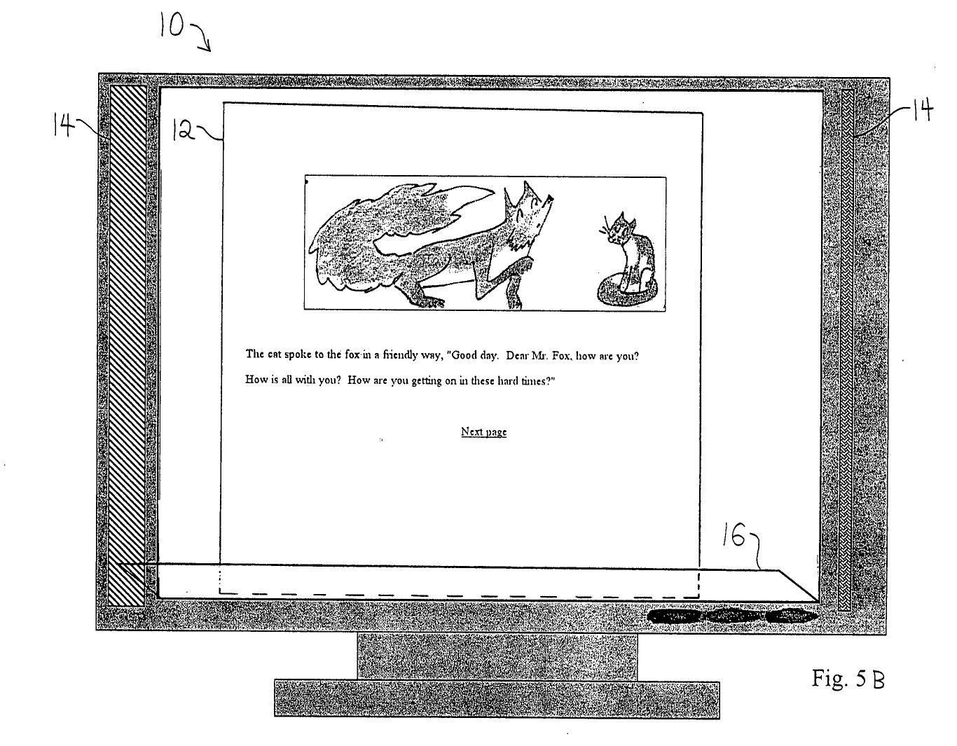

FIG. 5A shows the same page of electronic textual material as FIG. 1A. The monitor has a rectangular area on the left side of the casing adjacent to the screen that is colored with diagonal lavender and purple stripes. The lighter colored lavender diagonal stripes are raised, so that the area has a feel like a fingernail file. On the right side of the casing, along the screen is a narrower rectangular area that has a texture like woven straw or burlap and is a light rose color.

FIG. 5B shows a reading stand 10 (e.g., a physical frame of a material such as wood or metal) for placing a book or other physical page 12 upon, and which incorporates another preferred embodiment of the invention. The reading stand 10 incorporates an asymmetric design 14 such as shown in FIG. 5B, to help a person distinguish right from left by placing the physical page upon the reading stand. The reading stand 10 may have a lip 16 and/or a clip (not shown) for securing the book or physical page 12 thereto. Although FIG. 5B shows an asymmetrical design 14 similar to the design of FIG. 5A, the asymmetrical design 14 may take the form of any of the previously or subsequently described designs.

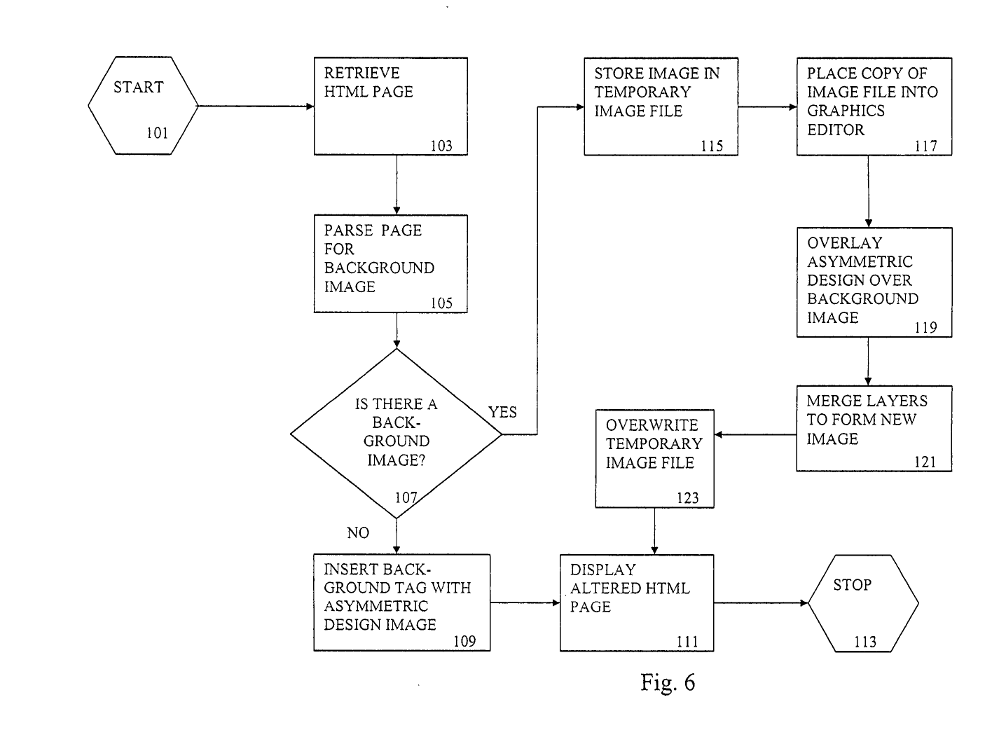

FIG. 6 shows a flow chart of one preferred embodiment of the invention in which the invention is embodied as software for displaying HTML pages.

The asymmetrical design, interchangeably referred to herein as a “left-right asymmetrical design,” preferably extends along substantially the entire left-right edges of the page and flanks the content portion of the page. The asymmetrical design does not necessarily have to abut or touch the extreme edge or edges of the page (whether physical or electronic) or the content region (for the display monitor and reading stand embodiments), but can be near the edge or edges, such as shown in FIGS. 5A and 5B with respect to the display monitor and reading stand embodiments. Likewise, the asymmetrical design does not necessarily have to extend along the entire left-right edges of the page (whether physical or electronic), but can extend along most of the left-right edges, or at least most of the edge portions that flank text to be read.

The left-right asymmetrical design may have no right edge image, as shown in exemplary FIG. 2A. That is, the lack of an image on the right edge provides the left-right asymmetry to the design. In other embodiments, the right edge image exists but differs in some manner from the left edge image, thereby providing the left-right asymmetry.

### II. Detailed Disclosure

FIG. 2A shows one preferred embodiment of the present invention for textual material printed on a physical medium. A solid lavender stripe is added approximately ⅝ inch wide to the page in FIG. 1. The lavender stripe on the left side of every page runs along the left edge of the page from the top of the page to the bottom of the page. Additional alternative embodiments are described below.

1. For use with electronic textual material: A solid lavender stripe is added approximately ⅝ inch wide to the background image of a page when it is electronically displayed.

2. A solid lavender stripe approximately ⅝ inch wide is displayed on the left side of every page (running along the left edge of the page from the top of the page to the bottom of the page) and a red stripe approximately 1½ inches wide is displayed along the right edge of the page. The stripes differ in both size and color. In this embodiment, the colors are chosen to help the user learn to distinguish left from right, in the sense that the word “lavender” (the color on the left) is alliterative with the word “left” and the word “red” (the color on the right) is alliterative with the word “right.” A student with a spatial problem learns to read from lavender to red, (i.e., from left to right). The visual stripe always reminds the student of the correct spatial orientation for sequencing tasks in reading. The chosen color names are alliterative with the directions they represent and may help the student overcome the need for such visual cues.

3. Stripes are both the same width (not necessarily ⅝ inch or 1½ inches wide), but the left stripe is one color (not necessarily lavender) and the right stripe is a different color (not necessarily red). In another alternative embodiment, the stripes are both the same color, but different widths.

6. Colors and widths are chosen to suit the visual acuities of the student. For example, different colors are chosen to accommodate a particular color blindness or particular ability to distinguish color contrasts or intensities. In other alternative embodiments, colors are changed to suit different languages, so that the color chosen for “left” is alliterative with the word in that language for “left” and the color for “right” is alliterative with the word in that language for “right”.

7. The stripe is not solid, but is a design such as a barber pole (diagonal stripes) or column of stars. In other alternative embodiments, the pattern on the left stripe differs from the patterns on the right stripe.

8. For a language which reads from top to bottom and from left to right (such as English), the left stripe has a column of arrows pointing up and the right stripe has a column of arrows pointing down. This is illustrated in FIG. 3. In an alternative embodiment for a language which reads from top to bottom and from right to left (such as Hebrew), the left stripe has a column of arrows pointing down, and the right stripe has a column of arrows pointing up. This helps a student to remember to start reading each page at the top of the appropriate side of the page and to read down and towards the other side.

9. The design on one side of the page includes the word for that side of the page. For example, in English, the design for the left edge of a page is the word “left” in lavender type 1 inch wide, or the design is a pattern with the word “left” repeated in the design.

10. There is a stripe or design on only one edge of the page. For example, a lavender stripe appears on the left edge of each page.

11. Where the textual material is physically manifest as in a printed book (such as one printed on paper, cardboard, vinyl or other media), the asymmetric design has both visual and tactile elements. For example, one stripe is raised or randomly bumpy, whereas another stripe has rows of parallel ridges so that it feels like a metal fingernail file. In one embodiment, the left and right are distinguished by both color and tactile feel. In another embodiment, the left and right are distinguished by color alone or by tactile feel alone. In an alternative embodiment, for textual material on a physical medium, the asymmetric design has only tactile elements.

12. Where the textual material is an electronic book, the asymmetric design is animated. For example, a stripe consisting of a column of arrows pointing up is animated so that the arrows appear to move in an upwards direction. As another example, a stripe that looks like a diagonally striped barber pole is animated so that it appears to rotate. As another example, a stripe consisting of a column of stars is animated so that the stars blink or twinkle or change color.

13. For displaying electronic textual material written in HTML, the asymmetric design is specified by using the background tag for the displayed page, as opposed to the page as it is written and stored on its website. In an alternative embodiment, the asymmetric design is inserted into a layer on the page. In an alternative embodiment, the asymmetric design is specified in a cascading style sheet (or other type of style sheet). In other alternative embodiments, the asymmetric design is displayed on the computer using XML, VBscript, DHTML, Java script, Java or some other computer language. In other alternative embodiments, the asymmetric design is constructed by the computer in tables or frames. In other alternative embodiments, the asymmetric design is displayed using a gif file, jpeg file, bmp file, or any other image format. The image file may be a single image or an animated one. Animation and the asymmetric design may also created and displayed using Flash files, wmv files, other media files, an applet, and other embedded objects.

One advantage of these electronic embodiments is that the asymmetric design can be easily changed or swapped out for readers who do not need it, or for readers with particular visual acuities (such as color blindness) which require a different design or color combination. In some electronic embodiments, the user can select a variety of settings, such as (a) whether the design shows on both the left and the right, or only on one side, (b) the width of the design with each side configurable separately, (c) the color(s) of the design, (d) the pattern(s) of the design, (e) the graphic(s) or image(s) incorporated into the design(s), or (f) whether and how to animate the design(s).

14. For displaying electronic text: Electronically parse the page before it is displayed and swap out any image or color designated as a background or watermark and replace that image or color with an image of the embodiment's asymmetric design.

15. For displaying electronic text: Electronically parse the page and strip out the background or watermark image. Alter the background or watermark image by stripping out the pixels on each side and replacing those pixels with the pixels of the embodiment's asymmetric design. Then, this embodiment substitutes the new image (which looks like the asymmetric design overlaid on the original background) as the background or watermark.

Referring to FIG. 6, when the process for displaying electronic text starts (101), the document viewer retrieves an HTML page (103). Retrieval may be from any source including the Internet, an intranet, a computer hard drive, or insertable media (including, but not limited to, a floppy disc, a CD ROM, and Disk-on-Key flash memory). Software parses the page for HTML code specifying a background image (105) and determines whether there is such code and an accompanying background image (107). If there is no background image (or background color), the code is inserted to specify the asymmetric design as the background image (109). The HTML page, with the newly specified background image, is displayed on the computer monitor (111), and the process ends (113). On the other hand, if the software determines that an HTML background tag specifying a background image (or background color) exists (107), the software stores that image or color in a temporary file (115). The software then places that image in a graphics editor, or graphics editing software module (117). The software instructs the graphics editor to overlay the asymmetric design over the background image (or color) in the graphics editor (119), as a new layer or as an overlay. The graphics editor then merges the two images or layers to form a new image (121). The new image replaces the original background image in the temporary image file, overwriting that original background image (123). The HTML page is then displayed in the document viewer (111). The page is altered because the background image has been altered (although the HTML coding remains unchanged). Then, the process stops (113). Although FIG. 6 describes an embodiment viewing HTML pages, the asymmetric design can be added to pages written in other formats using analogous flowcharts as is known by those skilled in the art.

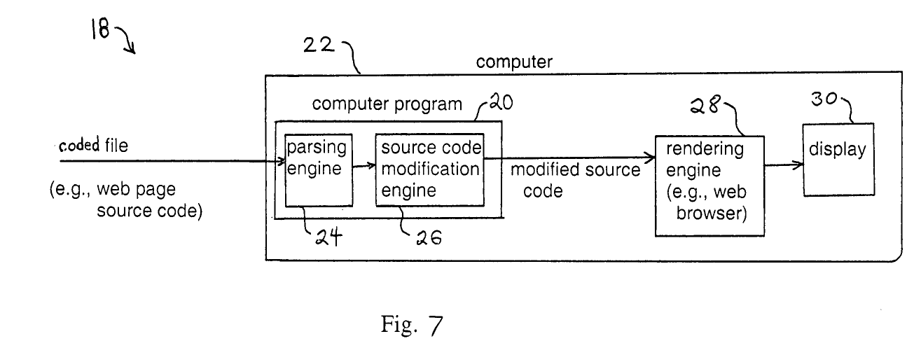

FIG. 7 shows a system 18 for implementing the method of FIG. 6 in accordance with one preferred embodiment of the present invention. A coded file, such as web page source code, is input into a computer program 20 of a computer 22. The computer program 20 includes a parsing engine 24 and a source code modification engine 26. The computer program 22 outputs modified source code which is received and processed by a rendering engine 28, such as a web browser, and displayed on a display 30.

Additional alternative preferred embodiments related to electronic text are described below.

1. Parse the page, strip out the background or watermark image and alter it by shifting all pixels of the image to the right (or left) a sufficient number of pixels to insert the stripe or other asymmetric design on the left (or right) side of the background or watermark image.

2. Parse the page, strip out the background or watermark image, and overlay the asymmetric design over it with a transparency value, so that the original background image shows at least somewhat through the asymmetric design.

3. Parses the page, add a layer (or layers) to the page above the background and below any other layers. This new layer(s) incorporates the asymmetric design. It can be opaque or transparent and can have varying transparencies.

4. Use an animated image or images as part of the asymmetric design in the new layer(s).

The above four embodiments rely upon common parsing techniques known to those of ordinary skill in the art of automatic server-side web page construction.

5. Do not change the appearance of the page itself but rather generate a tool bar or tool bars on the right or left side (or both sides) of the viewing window of the viewing software. These tool bars are affixed to the side rather than floating. The toolbars are colored or decorated. These colorings and decorations become the asymmetric designs of the invention. They always show and the page is displayed between them. Methods of constructing tool bars are known by those skilled in the art of programming personal computers.

6. Do not change the appearance of the page itself, or add toolbars to the viewing window, but rather construct a window with wider borders on one or both sides. The wider borders display the asymmetric design of the invention. This embodiment essentially constructs a new “skin” for the viewing window, the methods of which are known to those of ordinary skill in the art of programming window interfaces. (Similar window interfaces and programming techniques are used in a variety of operating systems, including both the Microsoft Windows operating system and the Apple Mac operating system.) Skins incorporate either static or dynamic graphics and designs. This embodiment of the present invention may, likewise, incorporate either static or dynamic graphics and designs. Thus, the new skin is specifically designed to provide a left-right asymmetrical design. Conventional skin changers are not used for this purpose.

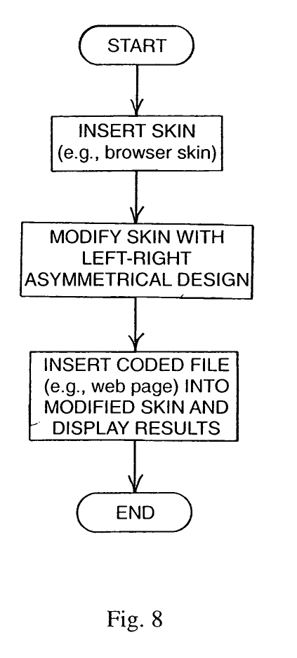

FIG. 8 shows a self-explanatory flowchart of the “new skin” embodiment.

7. The hardware (such as a computer monitor) for displaying the electronic text is painted (or otherwise colored) asymmetrically, with an area on the casing on the left of the screen being colored lavender and purple and constructed with a distinct texture, whereas an area on the casing to the right of the screen is colored a distinct rose with a different texture. This is illustrated in FIG. 5A. In contrast, FIG. 4 shows how the page (FIG. 1A) looks in a standard monitor.

8. The computer monitor is painted lavender on the casing on the left of the screen with the casing on the right of the screen colored red.

9. Alternative embodiments for hardware can incorporate the same asymmetric design elements described in the above software viewers.

10. The asymmetric design on the hardware has visual and/or tactile elements, such as described below:
a. One stripe is raised or randomly bumpy whereas another stripe may consist of rows of parallel ridges so that it feels like a metal fingernail file. The left and right are distinguished by both color and tactile feel, by color alone, or by tactile feel alone.
b. The hardware casing has lights asymmetrically placed, colored or blinked on the casing.
c. The asymmetric design on the hardware has a moving mechanical item, such as a barber pole placed on one or both sides of the casing.

In an alternative embodiment in the form of a reading stand for holding a physical page, the stand incorporates asymmetric designs as described above with respect to a computer monitor.

Specific embodiments previously described above are illustrated in the following figures:

FIG. 1B shows a left-right asymmetrical design in the form of vertical bars flanking the left and right edges of a coded file (e.g., web page) content portion, each having different colors, wherein the second color is visually distinct from the first color. The right edge vertical bar is optional.

FIG. 1C shows a left-right asymmetrical design in the form of vertical bar-shaped regions flanking the left and right edges of a web page content portion wherein the design on the left edge contains one or more of the words “left” and the design on the right edge contains one or more of the words “right.” The right edge vertical bar-shaped region is optional.

FIG. 1D shows a left-right asymmetrical design in the form of vertical bars flanking the left and right edges of a web page content portion, each having different widths.

FIG. 1E shows a left-right asymmetrical design in the form of vertical bars flanking the left and right edges of a web page content portion, each having different designs. The right edge vertical bar-shaped region is optional.

FIGS. 2B-2F show left-right asymmetrical designs associated with a printed publication similar to those described above for use in a web page. FIG. 2F also shows the use of different textures on each of the respective left and right edges.

### Additional Detailed Disclosure for Defining a Background Image

One embodiment of the invention adds a background image where there is none.

A tag in HTML is code that is included within two brackets such as <body> or <img>. The first is a body tag and the second is an image tag. A tag can have attributes, or items that customize the tag. These attributes appear within the brackets after the initial descriptor (e.g., “body”) and have a value usually placed in quotes. For example: <body bgcolor=“black”>. The attribute “bgcolor” is an attribute of the body tag. It will set a solid background color for a web page, in this example to “black”. Alternatively, the code Background=“File.gif” will define a background picture wherein File.gif is the name of the file you wish to use for the background. This code would be used in place of bgcolor. “File.gif” is the entire address of an image file that can be read by the browser. It can be a “gif” file or a “jpeg” file. (There also may be other image formats that a browser can directly display.) These are two different types of files for compressing or coding images. Each has a different extension (the last three letters in the address or file name that come after the last period). A gif file ends in “.gif”. A jpeg file ends in “.jpg”. As to the entire address, this can be just the file name if the file is held in the same folder on the server as the web page. It can be a complete web address that includes the entire URL, e.g., http://www.simtalk.com/bibli/biblibook.gif. It can also be a “relative” address, for example, a location in a subfolder or parent folder on the same server as the web page that uses the image. As an example, a webpage in the basic folder of www.simtalk.com can include the above mentioned image by specifying simply “bibli/biblibook.gif”. If the image does not fill the screen, the browser will automatically repeat the image (or tile it) to fill the screen.

A background image is sometimes called a “watermark”. Usually this is a very light image. Sometimes background images are designed to be fixed (scrolling the text on the page will not move the background image) and sometimes they are designed to scroll with the text on the page. Adding an attribute “Bgproperties=″Fixed” to the body tag will prevent the background from scrolling along with the page. If it is desired to allow the background to scroll, this attribute should not be added.

Additional explanation regarding the “background” attribute of the body tag is provided in a web page at: http://www.civ3files.com/cgi-bin/TotalHTML/Load.cgi?Page=Body.shtml, ©Copyright 2003 Dustin Smith and Yuhao Lin.

Another embodiment of the present invention changes the effective background image. This can be done by taking the image, and altering it so that stripes or other left-right design elements are added to it. The same effect can also be accomplished by creating three side-by-side frames (or a table with three horizontal cells), so that the outer frames (or cells) contain the left-right design elements and the center frame (or cell) contains the entire original web page.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

1. A method of modifying an original coded file to become a coded file that, when displayed, allows for enhanced readability by a reader who has difficulty in distinguishing left from right while reading, the original coded file being defined by source code including a content portion having at least text designated for display, the method comprising:
(a) inputting source code of a coded file into a computer program; and
(b) modifying the source code of the coded file in the computer program with additional source code that inserts a left-right asymmetrical design into the source code of the coded file that appears on the image of the coded file when the coded file is rendered on a display screen, the asymmetrical design extending along at least the left-right edges of the coded file content portion that flanks text to be read, the asymmetrical design being used by the reader to assist in distinguishing left from right while reading a display of the coded file content portion.

2. The method of claim 1 wherein the coded file is a web page.

3. The method of claim 2 wherein the web page source code does not include source code for defining a background image, and step (b) further comprises modifying the web page source code by inserting a background image into the web page source code having the left-right asymmetrical design.

4. The method of claim 2 wherein the web page source code includes source code for defining a background image, and step (b) further comprises modifying the web page source code so as to cause the left-right asymmetrical design to overlay the background image.

5. The method of claim 1 wherein the asymmetrical design includes a plurality of upward pointing arrows, one on top of the other.

6. The method of claim 5 wherein the asymmetrical design further includes a plurality of downward pointing arrows, one below the other.

7. The method of claim 1 wherein the asymmetrical design includes a first vertical bar-shaped region extending along at least the left edge of the coded file content portion that flanks text to be read and having a first design that contains one or more of the word: left.

8. The method of claim 7 wherein the asymmetrical design further includes a second vertical bar-shaped region extending along at least the right edge of the coded file content portion that flanks text to be read and having a second design that contains one or more of the word: right.

9. The method of claim 1 wherein the asymmetrical design includes a first vertical bar extending along at least the left edge of the coded file content portion that flanks text to be read.

10. The method of claim 9 wherein the first vertical bar has a first color, the asymmetrical design further comprising a second vertical bar extending along at least the right edge of the coded file content portion that flanks text to be read and having a second color visually distinct from the first color.

11. The method of claim 1 wherein the asymmetrical design extends along substantially the entire left-right edges of the coded file content portion.

12. The method of claim 1 wherein the asymmetrical design is animated.

13. The method of claim 1 wherein the asymmetrical design includes:
(i) a first vertical bar extending along at least the left edge of the coded file content portion that flanks text to be read and having a first width, and
(ii) a second vertical bar extending along at least the right edge of the coded file content portion that flanks text to be read and having a second width different than the first width.

14. The method of claim 1 wherein the asymmetrical design includes:
(i) a first vertical bar-shaped region extending along at least the left edge of the coded file content portion that flanks text to be read and having a first design, and
(ii) a second vertical bar-shaped region extending along at least the right edge of the coded file content portion that flanks text to be read and having a second design that is visually distinct from the first design.

15. The method of claim 1 wherein the asymmetrical design includes a vertical bar extending along at least the left edge of the coded file content portion that flanks text to be read and no asymmetrical design extending along any portion of the right edge of the page that flanks the text to be read, the content portion thereby extending to the right edge of the coded file content portion.

16. The method of claim 1 wherein the asymmetrical design is obtained from one or more image files.

17. An article of manufacture for modifying an original coded file to become a coded file that, when displayed, allows for enhanced readability by a reader who has difficulty in distinguishing left from right while reading, the original coded file being defined by source code including a content portion having at least text designated for display, the article of manufacture comprising a computer-readable medium holding computer-executable instructions for performing a method comprising:
(a) inputting source code of a coded file into a computer program; and
(b) modifying the source code of the coded file in the computer program with additional source code that inserts a left-right asymmetrical design into the source code of the coded file that appears on the image of the coded file when the coded file is rendered on a display screen, the asymmetrical design extending along at least the left-right edges of the coded file content portion that flanks text to be read, the asymmetrical design being used by the reader to assist in distinguishing left from right while reading a display of the coded file content portion.

18. The article of manufacture of claim 17 wherein the coded file is a web page.

19. The article of manufacture of claim 18 wherein the web page source code does not include source code for defining a background image, and step (b) further comprises modifying the web page source code by inserting a background image into the web page source code having the left-right asymmetrical design.

20. The article of manufacture of claim 18 wherein the web page source code includes source code for defining a background image, and step (b) further comprises modifying the web page source code so as to cause the left-right asymmetrical design to overlay the background image.

21. The article of manufacture of claim 17 wherein the asymmetrical design includes a plurality of upward pointing arrows, one on top of the other.

22. The article of manufacture of claim 21 wherein the asymmetrical design further includes a plurality of downward pointing arrows, one below the other.

23. The article of manufacture of claim 17 wherein the asymmetrical design includes a first vertical bar-shaped region extending along at least the left edge of the coded file content portion that flanks text to be read and having a first design that contains one or more of the word: left.

24. The article of manufacture of claim 23 wherein the asymmetrical design further includes a second vertical bar-shaped region extending along at least the right edge of the coded file content portion that flanks text to be read and having a second design that contains one or more of the word: right.

25. The article of manufacture of claim 17 wherein the asymmetrical design includes a first vertical bar extending along at least the left edge of the coded file content portion that flanks text to be read.

26. The article of manufacture of claim 25 wherein the first vertical bar has a first color, the asymmetrical design further comprising a second vertical bar extending along at least the right edge of the coded file content portion that flanks text to be read and having a second color visually distinct from the first color.

27. The article of manufacture of claim 17 wherein the asymmetrical design extends along substantially the entire left-right edges of the coded file content portion.

28. The article of manufacture of claim 17 wherein the asymmetrical design is animated.

29. The article of manufacture of claim 17 wherein the asymmetrical design includes:
(i) a first vertical bar extending along at least the left edge of the coded file content portion that flanks text to be read and having a first width, and
(ii) a second vertical bar extending along at least the right edge of the coded file content portion that flanks text to be read and having a second width different than the first width.

30. The article of manufacture of claim 17 wherein the asymmetrical design includes:
(i) a first vertical bar-shaped region extending along at least the left edge of the coded file content portion that flanks text to be read and having a first design, and
(ii) a second vertical bar-shaped region extending along at least the right edge of the coded file content portion that flanks text to be read and having a second design that is visually distinct from the first design.

31. The article of manufacture of claim 17 wherein the asymmetrical design includes a vertical bar extending along at least the left edge of the coded file content portion that flanks text to be read and no asymmetrical design extending along any portion of the right edge of the page that flanks the text to be read, the content portion thereby extending to the right edge of the coded file content portion.

32. The article of manufacture of claim 17 wherein the asymmetrical design is obtained from one or more image files.

33. A method of displaying text on a display screen in a manner that allows for enhanced readability by a reader who has difficulty in distinguishing left from right while reading text, the text being defined in a coded file that includes a content portion having at least text designated for display, the method comprising:
(a) providing a skin for a software program that electronically displays the coded file; and
(b) modifying the skin to insert a left-right asymmetrical design into the skin so that the left-right asymmetrical design appears on the skin when the skin is displayed on the display screen, the asymmetrical design extending along substantially the entire left-right edges of the coded file content portion and flanking the coded file content portion, the asymmetrical design extending along at least the left-right edges of the coded file content portion that flanks text to be read, the asymmetrical design being used by the reader to assist in distinguishing left from right while reading a display of the coded file content portion.

34. The method of claim 33 wherein the asymmetrical design extends along substantially the entire left-right edges of the coded file content portion.

35. The method of claim 33 wherein the coded file is a web page and the skin is a browser skin of a web browser.

36. An article of manufacture for displaying text on a display screen in a manner that allows for enhanced readability by a reader who has difficulty in distinguishing left from right while reading text, the text being defined in a coded file that includes a content portion having at least text designated for display, the article of manufacture comprising a computer-readable medium holding computer-executable instructions for performing a method comprising:
(a) providing a skin for a software program that electronically displays the coded file; and
(b) modifying the skin to insert a left-right asymmetrical design into the skin so that the left-right asymmetrical design appears on the skin when the skin is displayed on the display screen, the asymmetrical design extending along at least the left-right edges of the coded file content portion that flanks text to be read, the asymmetrical design being used by the reader to assist in distinguishing left from right while reading a display of the coded file content portion.

37. The method of claim 36 wherein the asymmetrical design extends along substantially the entire left-right edges of the coded file content portion.

38. The article of manufacture of claim 36 wherein the coded file is a web page and the skin is a browser skin of a web browser.

39. A reading display surface that allows for enhanced readability by a reader who has difficulty in distinguishing left from right while reading, the reading display surface comprising:
(a) a content region; and
(b) a left-right asymmetrical design, the asymmetrical design extending along substantially the entire left-right edges of the content region and flanking the content region, the asymmetrical design being used by the reader to assist in distinguishing left from right while reading content in the content region.

40. The reading display surface of claim 39 wherein the asymmetrical design includes a plurality of upward pointing arrows, one on top of the other.

41. The reading display surface of claim 40 wherein the asymmetrical design further includes a plurality of downward pointing arrows, one below the other.

42. The reading display surface of claim 39 wherein the asymmetrical design includes a first vertical bar-shaped region flanking the left edge of the content region and having a first design that contains one or more of the word: left.

43. The reading display surface of claim 42 wherein the asymmetrical design further includes a second vertical bar-shaped region flanking the right edge of the content region and having a second design that contains one or more of the word: right.

44. The reading display surface of claim 39 wherein the asymmetrical design includes a first vertical bar flanking the left edge of the content region.

45. The reading display surface of claim 44 wherein first vertical bar has a first color, the asymmetrical design further comprising a second vertical bar flanking the right edge of the content region and having a second color visually distinct from the first color.

46. The reading display surface of claim 39 wherein the asymmetrical design includes:
(i) a first vertical bar flanking the left edge of the content region and having a first width, and
(ii) a second vertical bar flanking the right edge of the content region and having a second width different than the first width.

47. The reading display surface of claim 39 wherein the asymmetrical design includes:
(i) a first vertical bar-shaped region flanking the left edge of the content region and having a first design, and
(ii) a second vertical bar flanking the right edge of the content region and having a second design that is visually distinct from the first design.

48. The reading display surface of claim 39 wherein the asymmetrical design includes a vertical bar flanking the left edge of the content region and no asymmetrical design flanking the right edge of the content region.

49. The reading display surface of claim 39 wherein the reading display surface is a computer monitor having (i) a display portion, and (ii) an outer casing, the content region being the display portion of the computer monitor and the left-right asymmetrical design extending along substantially the entire left-right edges of the outer casing.

50. The reading display surface of claim 39 wherein the asymmetrical design includes:
(i) a first vertical bar flanking the left edge of the content region and having a first texture, and
(ii) a second vertical bar flanking the right edge of the content region and having a second texture that is visually distinct from the first texture.

51. The reading display surface of claim 39 wherein the reading display surface is a reading stand having (i) a portion where reading material is placed, and (ii) outer edges, the content region being the portion where reading material is placed and the left-right asymmetrical design extending along substantially the entire left-right edges of the outer edges.

52. A printed publication that allows for enhanced readability by a reader who has difficulty in distinguishing left from right while reading, the printed publication having one or more pages, each page comprising:
(a) a content portion; and
(b) a left-right asymmetrical design, the asymmetrical design extending along at least the left-right edges of the page that flank the content portion, the asymmetrical design being used by the reader to assist in distinguishing left from right while reading the content portion.

53. The printed publication of claim 52 wherein the asymmetrical design includes a plurality of upward pointing arrows, one on top of the other.

54. The printed publication of claim 53 wherein the asymmetrical design further includes a plurality of downward pointing arrows, one below the other.

55. The printed publication of claim 52 wherein the asymmetrical design includes a first vertical bar-shaped region extending along at least the left edge of the page that flanks the content portion and having a first design that contains one or more of the word: left.

56. The printed publication of claim 55 wherein the asymmetrical design further includes a second vertical bar-shaped region extending along at least the right edge of the page that flanks the content portion and having a second design that contains one or more of the word: right.

57. The printed publication of claim 52 wherein the asymmetrical design includes a first vertical bar extending along at least the left edge of the page that flanks the content portion.

58. The printed publication of claim 57 wherein first vertical bar has a first color, the asymmetrical design further comprising a second vertical bar extending along at least the right edge of the page that flanks the content portion and having a second color visually distinct from the first color.

59. The printed publication of claim 52 wherein the asymmetrical design extends along substantially the entire left-right edges of the page.

60. The printed publication of claim 52 wherein the asymmetrical design includes:
(i) a first vertical bar extending along at least the left edge of the page that flanks the content portion and having a first width, and
(ii) a second vertical bar extending along at least the right edge of the page that flanks the content portion and having a second width different than the first width.

61. The printed publication of claim 52 wherein the asymmetrical design includes:
(i) a first vertical bar-shaped region extending along at least the left edge of the page that flanks the content portion and having a first design, and
(ii) a second vertical bar-shaped region extending along at least the right edge of the page that flanks the content portion and having a second design that is visually distinct from the first design.

62. The printed publication of claim 52 wherein the asymmetrical design includes a vertical bar extending along at least the left edge of the page that flanks the content portion and no asymmetrical design extending along any portion of the right edge of the page that flanks the content portion, the content portion thereby extending to the right edge of the page.

63. The printed publication of claim 52 wherein the asymmetrical design includes:
(i) a first vertical bar extending along at least the left edge of the page that flanks the content portion and having a first texture, and
(ii) a second vertical bar extending along at least the right edge of the page that flanks the content portion and having a second texture that is visually distinct from the first texture.
